(19) United States
(12) Patent Application Publication
(10) Pub. No.: US 2015/0380888 A1
(43) Pub. Date: Dec. 31, 2015

(54) SLIP RING ARRANGEMENT

(71) Applicant: ABB Technology AG, Zürich (CH)

(72) Inventor: Teemu Jehkonen, Järvenpää (FI)

(21) Appl. No.: 14/765,781

(22) PCT Filed: Feb. 5, 2014
(86) PCT No.: PCT/EP2014/052223

§ 371 Date: Aug. 4, 2015

(30) Foreign Application Priority Data
Feb. 7, 2013 (EP) 13154370.4

(51) Int. Cl. H01R 39/64

(52) U.S. Cl. CPC H01R 39/64

(57) ABSTRACT

Slip arrangement (100) for transferring electric power between a stationary part (1) and a rotatable part (20) comprises annular slip rings (101, 102, 103) positioned coaxially around a centre axis (Y) at a radial distance from each other and having at least one contact surface (S1, S2). Optional first power supply conductors (111, 112, 113) are attached to the at least one contact surface (S1, S2) of the slip rings (101, 102, 1013). Sliding contact means (131, 32, 133) having a contact surface (S3) are in sliding contact with the at least one contact surface (S1, S2) of the slip rings (101, 102, 103). Second power supply conductors (121, 122, 123) are attached to the sliding contact means (121, 122, 123). The first power supply conductors (111, 112, 113) are sup-ported with first isolator means (141, 142, 143) and further first isolator means 1 (145) at the rotating part (20) or the stationary part (10) and the second power supply conductors (121, 122, 123) are supported with second isolator means (151, 152, 153) and further second isolator means (155) at the stationary part (10) or the rotating part (20). Said sliding contact means (131, 132, 133) are stationary and said slip rings (101, 102, 103) rotate with the rotating part (20) 20 or vice a versa.

### FIELD OF THE INVENTION

The present invention relates to a slip ring arrangement according to the preamble of claim 1.

### BACKGROUND ART

DE 4406042 discloses an electrical connection for a rotatable spot-light. The arrangement comprises a first pair of concentric electrically conductive cylinders positioned above a second pair of concentric electrically conductive cylinders. The first pair of cylinders and the second pair of cylinders have a common axis of rotation and the diameters of the cylinders in the first pair of cylinders correspond to the diameters of the respective cylinders in the second pair of cylinders. Each cylinder in the first pair of cylinders comprises contact springs extending downwards and being in contact with the inner surface of a respective cylinder in the second pair of cylinders. The first pair of cylinders are stationary and the second pair of cylinders rotate. A bar is positioned at the axis of rotation and passes through the arrangement. The incoming power phase is connected to the upper end of the bar and the outgoing power phase is connected to the lower end of the bar. The neutral and the ground are connected via the two pairs of cylinders. The cylinders in the first pair of cylinders are supported on a first isolated housing and the cylinders in the second pair of cylinders are supported on a second housing and extend also into the first housing. The first and the second housing are connected through further isolated housings.

EP patent publication 0 908 983 discloses an electrical transmission system to a propulsion and steering module for naval ships. A pod is connected with a stem to the ship, said stem being rotatable in relation to the ship. A first sliding contact means is coupled to the ship frame and connected to a first conductor of one or more pairs of conductors. A second sliding contact means is coupled to the stem of the ship and connected to a second conductor of said pair of conductors. A third sliding contact means in the form of rotating conductive rings is in continuous relative motion in relation to said first and second sliding contact means. Electric current is thus transferred between the first sliding contact means and the second contact sliding via the third sliding contact means i.e. the rotating rings. The second sliding contact means rotates with the stem as the pod is turned. The idea of continuously rotating the third sliding contact means is to eliminate micro-crates caused by local temperature increases. Local temperature increases might occur when the sip navigates at cruising speed for long periods without changing direction. The electric current flows thus through the same spots between the first and second sliding contact means, which might cause temperature increases in these spots. The slip ring arrangement is mounted on the vertically directed cylindrical stem i.e. the phases are positioned on the vertically directed cylindrical outer surface of the stem at a vertical distance from each other. This arrangement becomes thus rather high in the vertical direction.

GB patent publication 2 167 612 discloses a horizontal axis wind-turbine system having a nacelle-mounted generator being provided with a slip ring assembly. The slip ring assembly comprises a horizontal disc having two sets of annular slip rings located on opposite sides coaxial with the disc axis. Each slip ring on one side of the disc is connected to the corresponding slip ring on the opposite side of the disc. The slip rings are buried into grooves in the disc, which restricts dissipation of heat from the slip rings. The disc is mounted with an axis vertical and coincident with the axis of rotation of the nacelle. The upper set of slip rings is associated with brushes connected electrically to the generator output terminals and the lower set of slip rings is associated with brushes connected electrically to outgoing conductors. The disc is mounted to be rotated by an electric motor mounted within the tower at a speed chosen to give optimum sliding velocity between the brushes and the slip rings. The slip ring assembly comprises in an alternative embodiment instead of the rotating disc a rotating cylinder having a vertical axis. The two interconnected sets of slip rings are positioned on the outer surface of the cylinder and located at a vertical distance from each other. Each slip ring on the upper portion of the cylinder is connected to the corresponding slip ring on the lower portion of the cylinder.

U.S. Pat. No. 5,923,113 discloses a slip-ring arrangement for transfer of current, a liquid medium and a gaseous medium between a fixed section and a tubular section rotatable relative to the fixed section. The arrangement comprises slip rings supported by and rotating with the rotatable section and slidable brushes supported by the fixed section for transfer of current. The arrangement comprises further swivel joint arrangements for transfer of the gaseous medium and the liquid medium. The swivel joint arrangements are positioned coaxially in the space within the slip rings in order to reduce the total height of the arrangement. The slip rings are mounted one upon each other in the vertical direction of the rotating section. This arrangement can be used in vessels being driven by pods for transferring current to the electric motor in the pod and for transferring a gaseous and a liquid medium needed in the pod.

One problem in prior art slip-ring arrangements used in vessels for transferring current to the electric motor in the pod is the height of the arrangement. The slip-rings which are used to transfer current are stacked upon each other in the height direction of the rotating section. The electric motor in the pod is normally a three phase induction motor, which means that at least three slip-rings for the three power phases and at least one slip ring for the neutral phase are stacked upon each other with an air gap between the slip rings. The power of the electric motor in a pod is normally in the order of megawatts, which means that the currents to be transferred are in the order of kilo amperes. The slip-rings are thus rather heavy i.e. they are rather thick and have a considerable contact area. The current flowing through the slip-rings will produce a considerable amount of heat, which means that some kind of cooling has to be arranged. The heat must be able to dissipate from the slip rings and the heat must then be ventilated away from the slip-rings. Cooling has been arranged with fans blowing air through the arrangement.

### BRIEF DESCRIPTION OF THE INVENTION

An object of the present invention is to achieve an improved slip ring arrangement.

The slip ring arrangement according to the invention is characterized by what is stated in the characterizing portion of claim 1.

The slip ring arrangement for transferring electric power between a stationary part and a rotatable part comprises:

annular slip rings being positioned coaxially around a centre axis at a radial distance from each other, said slip rings being made of an electrically conductive material, said slip rings having a thickness and a width and at least one contact surface extending in the direction of the width of the slip ring,

optional first power supply conductors being connected to said at least one contact surface of the slip rings,

sliding contact means having a contact surface being adapted to said at least one contact surface of the slip rings and being in sliding contact with said at least one contact surface of the slip rings,

second power supply conductors being connected to the sliding contact means,

first isolator means extending between the slip rings and/or between the first power supply conductors and further first isolator means supporting the slip rings at the rotating part or the stationary part,

second isolator means extending between the second power supply conductors and further second isolator means supporting the sliding contact means at the stationary part or the rotating part,

wherein said sliding contact means are stationary and said slip rings rotate with the rotating part or vice a versa.

The arrangement of having the slip rings positioned coaxially around a centre axis at a radial distance from each other decreases the height of the arrangement considerably. A prior art slip ring arrangement for a 7,5 MW electric motor having the slip rings stacked one upon the other around a cylinder has a height of about 1.5 meters. The height can be reduced over 50% with a slip ring arrangement according to the invention. The reduced height will free space above the slip ring arrangement for other purposes.

The slip ring arrangement according to the invention could be used in a vessel having one or several pods with electric driving motors. The lower slip ring arrangement would make it possible to use the decks just above the slip ring arrangement more effectively. It might be possible to have ramps passing even over the slip ring arrangement on the lowest car deck.

The slip ring arrangement according to the invention could also be used in a wind turbine. The lower slip ring arrangement would free space above the slip ring arrangement to be used for other equipment.

The slip arrangement according to the invention is especially suitable to be used when the electrical power to be transferred is at least 1 MW and the electrical current is at least 1 kA.

The slip ring arrangement according to the invention is especially suitable to be used in a three phase L1, L2, L3 electrical power system with a neutral N. The slip ring arrangement comprises thus at least one slip ring for each phase L1, L2, L3 and at least one slip ring for the neutral N. Each phase L1, L2, L3 can be divided into two slip rings e.g. in cases where the current to be transferred is very big. This would mean that six slip rings are used for the phases L1, L2, L3 and one for the neutral N.

### BRIEF DESCRIPTION OF THE DRAWINGS

In the following the invention will be described in greater detail by means of preferred embodiments with reference to the attached drawings, in which:

FIG. 1 shows a vertical cross section of a pod arrangement in a vessel where a slip ring arrangement according to the invention can be applied.

FIG. 2 shows a horizontal cross section of a slip ring arrangement according to the invention.

FIG. 3 shows a vertical cross section of the slip ring arrangement according to FIG. 1.

FIG. 4 shows a vertical cross section of a second embodiment of the slip ring arrangement shown in FIG. 3.

FIG. 5 shows a vertical cross section of a third embodiment of a slip ring arrangement according to the invention.

FIG. 6 shows a vertical cross section of an arrangement for transferring liquid medium or gaseous medium between a stationary and a rotatable part.

FIG. 7 shows a vertical cross section of a slip ring arrangement for transfer of electric signals between a stationary and a rotatable part.

### DETAILED DESCRIPTION OF THE INVENTION

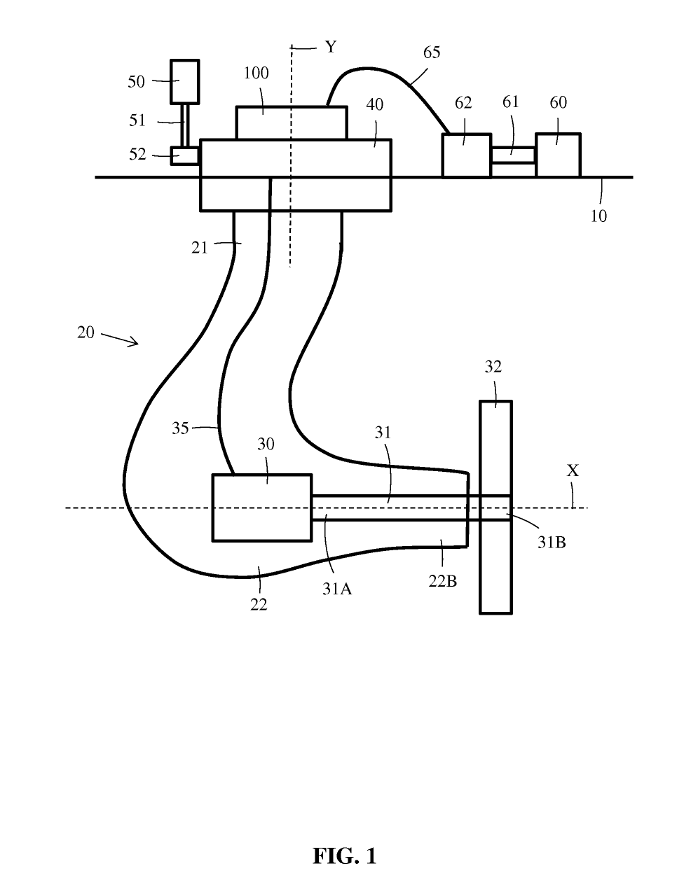

FIG. 1 shows a vertical cross section of a pod arrangement in a vessel where a slip ring arrangement according to the invention can be applied. The pod arrangement comprises a hollow pod 20 with an upper portion 21 and a lower portion 22. The pod 20 is attached from the upper portion 21 at a hull 10 of a vessel. The lower portion 22 of the pod 20 forms a longitudinal compartment comprising a first electric motor 30 and a first shaft 31. A first end 31A of the first shaft 31 is connected to the electric motor 30 and a second end 31 B of the first shaft 31 protrudes from an aft end 22B of the lower portion 22 of the pod 22. A propeller 32 is connected to the second outer end 31B of the first shaft 31. The axial centre line X of the first shaft 31 forms a shaft line. The pod 20 is rotatably attached to the vessel 10 via the upper portion 21 so that it can turn 360 degrees around a vertical centre axis Y. The upper portion 21 of the pod 20 is connected to a gearwheel 40 situated within the hull 10 of the vessel. A first end of a second shaft 51 is connected to a second electric motor 50 and a pinion wheel 52 is connected to a second opposite end of the second shaft 51. The cogs of the pinion wheel 52 are connected to the cogs of the gearwheel 40. The gearwheel 40 can thus be turned 360 degrees around the vertical centre axis Y with the second electric motor 50. There can naturally be several similar second electric motors 50 connected to the gearwheel 40. There is further an engine 60 within the vessel and a generator 62 connected with a third shaft 61 to the engine 60. The engine 60 can be a conventional diesel engine used in vessels. The generator 62 produces electric energy needed in the vessel 10 and the pod 20. There can be several diesel engines 60 and generators 62 in a vessel 10. There is further a slip ring arrangement 100 in connection with the gearwheel 40. Electric power is transferred from the generator 62 to the slip ring arrangement 100 with a first cable 65. Electric power is further transferred from the slip ring arrangement 100 to the first electric motor 30 with a second cable 35. The slip ring arrangement 100 is needed in order to transfer electric power between the stationary hull 10 of the vessel and the rotating pod 20.

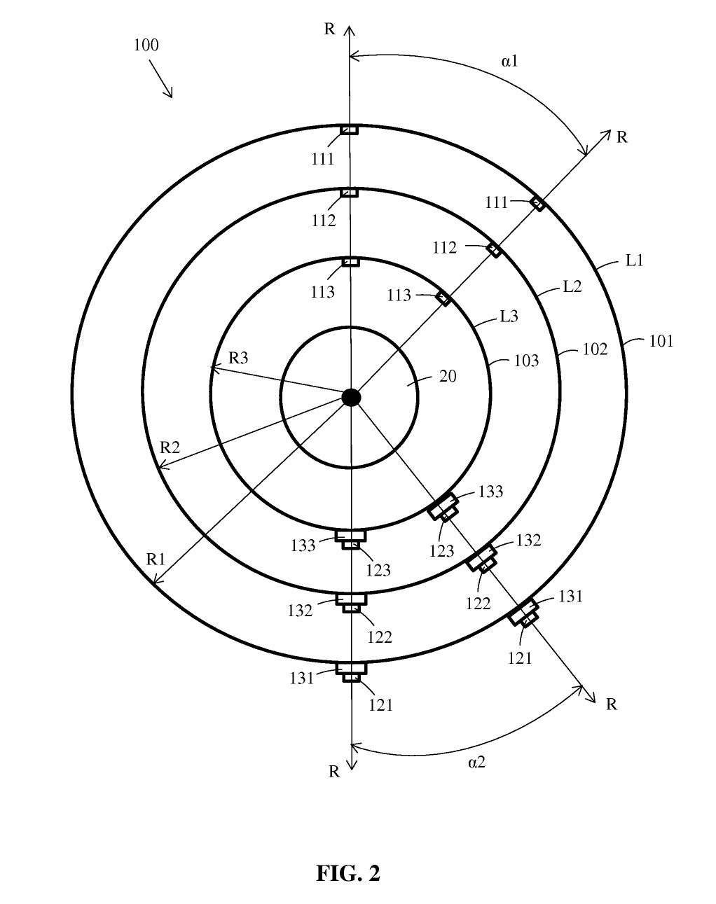

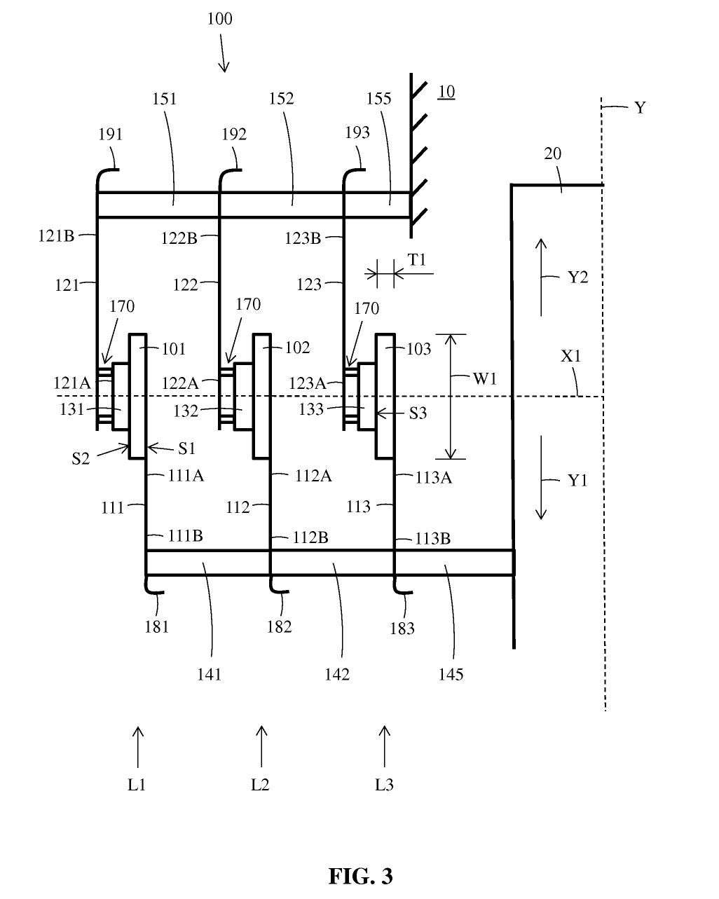

FIG. 2 shows a horizontal cross section and FIG. 3 shows a vertical cross section of a slip ring arrangement according to the invention. The slip ring arrangement 100 comprises annular slip rings 101, 102, 103 being positioned coaxially around the vertical centre axis Y at a radial distance from each other. The centre points of the annular slip rings 101, 102, 103 are positioned on a radial plane X1 being perpendicular to the vertical centre axis Y. The centre points of the sliding contact means 131, 132, 133 coincide with the centre points of the slip rings 101, 102, 103. There are three slip rings 101, 102, 103 in this embodiment i.e. one slip ring 101, 102, 103 for each phase L1, L2, L3, but there could be any number of slip rings. The slip rings 101, 103, 103 are made of an electrically conductive material and have a thickness T1 and a width W1 as well as two opposite contact surfaces S1, S2 extending along the width W1 of the slip ring 101, 102, 103. The slip rings 101, 102, 103 are circular i.e. they extend along the periphery of a circle having the centre on the vertical centre axis Y. The radius of the first slip 101 ring is R1, the radius of the second slip ring 102 is R2, and the radius of the third slip ring 103 is R3.

First power supply conductors 111, 112, 113 extend vertically downwards from the slip rings 101, 102, 103. A first upper end 111A, 112A, 113A of the first supply conductors 111, 112, 113 is attached to a respective slip ring 101, 102, 103 at a first contact surface S1 of the respective slip ring 101, 102, 103. Lower second ends 111B, 112B, 113B of the first power supply conductors 111, 112, 113 are attached to each other with first isolator means 141, 142 extending horizontally in the radial direction between the first power supply conductors 111, 112, 113. There is a further first isolator means 145 extending horizontally in a radial direction between the innermost first power supply conductor 113 and the rotatable part 20. Said further first isolator means 145 supports the whole first package consisting of the first power supply conductors 111, 112, 113, the first isolator means 141, 142 and the slip rings 101, 102, 103 at the rotating part 20. This means that the slip rings 101, 102, 103 rotate with the rotating part 20. The lower second ends 111B, 112B, 113B of the first power supply conductors 111, 112, 113 are connected with first cables 181, 182, 183 to the rotating part 20 into a common connection point for each phase L1, L2, L3. The input of the first electric motor 30 within the pod 20 can be connected with cables and/or bus bars 35 to the same common connection point for each phase L1, L2, L3 where the first cables 181, 182, 183 are connected.

Second power supply conductors 121, 122, 123 extend vertically upwards from the slip rings 101, 102, 103. A first lower end of the second power supply conductors 121, 122, 123 is attached via resilient means 170 e.g. spring means to the sliding contact means 121, 122, 123 sliding on a second opposite contact surface S2 of the slip rings 101, 102, 103. Second upper ends of the second power supply conductors 121, 122, 123 are supported at each other with second isolator means 151, 152 extending horizontally in a radial direction between the second power supply conductors 121, 122, 123. There is a further second insulator means 155 extending vertically in a radial direction between the innermost second power conductor 123 and the stationary part 10. Said further second isolator means 155 supports the whole second package consisting of the second power supply conductors 121, 122, 123, the second isolator means 151, 152, the resilient means 170 and the sliding contact means 131, 132, 133 at the stationary part 10. This means that the sliding contact means 131, 132, 133 are stationary in relation to the rotating slip rings 101, 102, 103. The upper second ends 121B, 122B, 123B of the second power supply conductors 121, 122, 123 are connected with second cables 191, 192, 193 to the stationary part 10 into a common connection point for each phase L1, L2, L3. The output of the generator 62 can be connected with cables and/or bus bars 65 to the same common connection point for each phase L1, L2, L3 where the second cables 191, 192, 193 are connected.

Electrical connection between the first power supply conductors 111, 112, 113 and the second power supply conductors 121, 122, 123 is formed via the slip rings 101, 102, 103 and the sliding contact means 131, 132, 133. Power can thus be transferred from the generator 62 positioned in the stationary part 10 i.e. the vessel to the first electric motor 30 positioned in the rotatable part i.e. the pod 20 through the slip ring arrangement 100.

The sliding contact means 131, 132, 133 will slide on the outer surface i.e. the second contact surface S2 of the rotating slip rings 101, 102, 103 as the rotatable part 20 rotates in relation to the stationary part 10. The stationary part 10 is stationary in relation to the hull 10 of the vessel and the rotatable part 20 is rotating with the pod 20. The sliding contact means 131, 132, 133 have a curved contact surface S3 that is adapted to the curved contact surface S1, S2 of the slip rings 101, 102, 103. The area of the curved contact surface S3 of the sliding contact means 131, 132, 133 must be big enough to be able to transfer the electric current needed in the application. The sliding contact means 131, 132, 133 are pressed by means of the resilient means 170 e.g. spring means towards the contact surface S1, S2 of the slip rings 101, 102, 103.

FIG. 2 shows only two sets of first power supply conductors 111, 112, 113 and only two sets of second power supply conductors 121, 122, 123 and sliding contact means 131, 132, 133. There are, however, more than two sets of first power supply conductors 111, 112, 113 distributed at equal angular distances around the circumference of the slip rings 101, 102, 103 as well as more than two sets of second power supply conductors 121, 122, 123 and sliding contact means 131, 132, 133 distributed at equal angular distances around the circumference of the slip rings 101, 102, 103. The number of sets of first power supply conductors 111, 112, 113 is at least 4, advantageously at least 8, and more advantageously at least 12. The first angle α1 between the sets of first power supply conductors 111, 112, 113 is 90 degrees when there are 4 sets, 45 degrees when there are 8 sets and 30 degrees when there are 12 sets of first power supply conductors 111, 112, 113. The number of sets of second supply conductors 121, 122, 123 and sliding contact means 131, 132, 133 is also at least 4, advantageously at least 8, and more advantageously at least 12. The second angle α2 between the sets of second power supply conductors 121, 122, 123 is 90 degrees when there are 4 sets, 45 degrees when there are 8 sets and 30 degrees when there are 12 sets of second power supply conductors 121, 122, 123. The current supplied to the slip rings 101, 102, 103 is thus divided into several parallel branches, which reduces the current in each branch considerably. The current supplied from the slip rings 101, 102, 103 is in the same way taken from the slip rings 101, 102, 103 with several branches. The currents used in slip ring arrangements can be in the order of several kilo amperes. The voltages used are normally in the order of hundreds of volts. The number of sets on the input side could be different compared to the number of sets on the output side, but the number of sets is advantageously the same at both sides.

Each set of first power supply conductors 111, 112, 113 is arranged coaxially on a radius R having its centre point on the centre axis Y. Each first power supply conductor 111, 112, 113 in a set is attached to a corresponding slip ring 101, 102, 103. Each set of second power supply conductors 121, 122, 123 and sliding contact means 131, 132, 133 is in a corresponding way arranged coaxially on a radius R having its centre point on the centre axis Y. Each sliding contact means 131, 132, 133 in a set is in sliding contact with a corresponding slip ring 101, 102, 103.

The slip rings 101, 102, 103 are in this embodiment in a vertical position i.e. the contact surfaces S1, S2 extend in the vertical direction along the width W1 of the slip rings 101, 102, 103. The slip rings 101, 102, 103 could naturally also be in a horizontal position i.e. the contact surfaces S1, S2 could extend in the horizontal direction along the width W1 of the slip rings 101, 102, 103. The first power supply conductors 111, 112, 113 would then have the shape of an inverted letter L. The slip rings 101, 102, 103 would be attached to the horizontal branch of the letter L. The second power supply conductors 121, 122, 123 would have the form of a letter L and the sliding contacts 131, 132, 133 would be attached to the horizontal branch of the letter L.

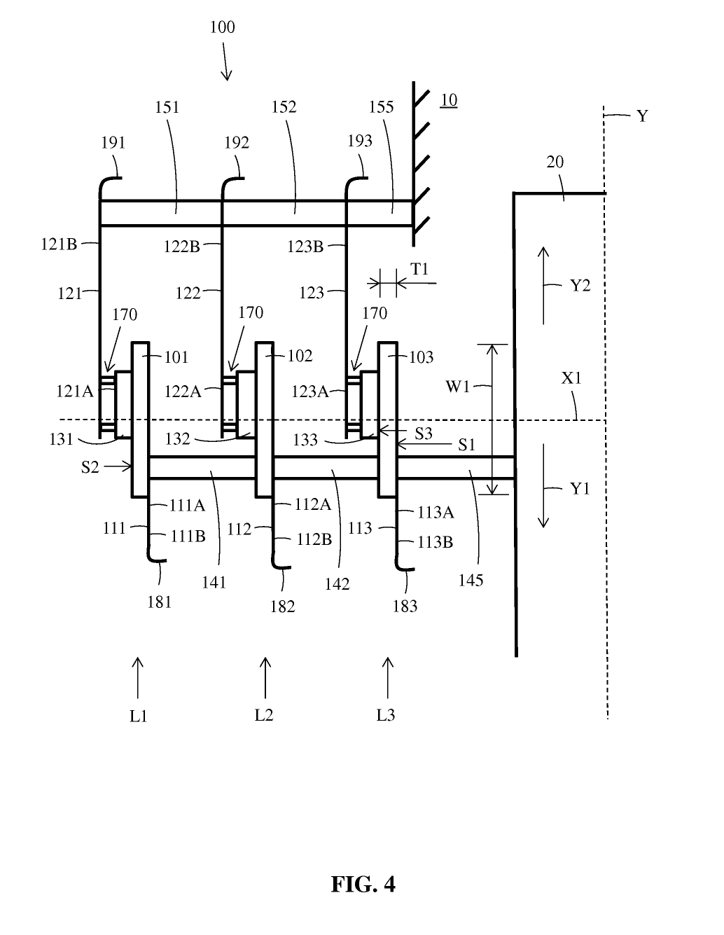

FIG. 4 shows a vertical cross section of a second embodiment of the slip ring arrangement shown in FIG. 3. The difference compared to the embodiment shown in FIG. 3 is that the first isolator means 141, 142 are positioned between the slip rings 101, 102, 103 instead of between the first power supply conductors 111, 112, 113. The sliding contact means 131, 132, 133 glide on the second contact surface S2 of the slip rings 101, 102, 103 above the first isolator means 141, 142 when the slip rings 101, 102, 103 rotate with the rotating part 20. The further first isolator means 145 extend between the innermost slip ring 103 and the rotating part 20. This means that the width W1 in the vertical direction of the slip rings 101, 102, 103 must be greater than in the embodiment shown in FIG. 3. The centre points of the slip rings 101, 102, 103 are positioned on a radial plane X1 being perpendicular to the vertical centre axis Y. The centre points of the sliding contact means 131, 132, 133 are above the centre points of the slip rings 101, 102, 103 in this embodiment. The first power supply conductors 111, 112, 113 are optional i.e. they are not necessary needed in this embodiment. The first cables 181, 182, 183 could be connected directly to the slip rings 101, 102, 103 at a position below the first isolator means 141, 142. In the case where there are first power supply conductors 111, 112, 113 connected to the slip rings 101, 102, 103 an additional row of first isolator means could be positioned between the first power supply conductors 111, 112, 113 and thus also a further first isolator means between the innermost first power supply conductor 113 and the rotating part 20. A first alternative would thus be to have only one row of first isolator means 141, 142 extending between the slip rings 101, 102, 103. A second alternative would be to have only one row of first isolator means 141, 142 extending between the first power supply conductors 111, 112, 113. A third alternative would be to have a first row of first isolator means 141, 142 extending between the slip rings 101, 102, 103 and a second row of first isolator means 141, 142 extending between the first power supply conductors 111, 112, 113.

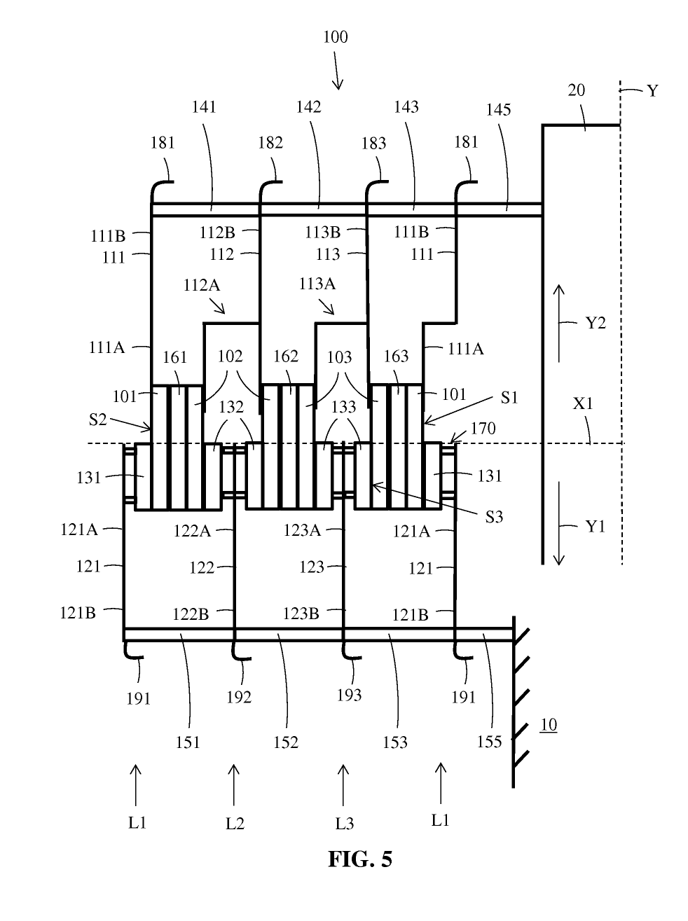

FIG. 5 shows a vertical cross section of a third embodiment of a slip ring arrangement according to the invention. This embodiment corresponds to the embodiment shown in FIGS. 2 and 3 except that this embodiment comprises two parallel slip rings 101, 102, 103 for each phase L1, L2, L3. Two parallel slip rings 101, 102, 103 for each phase L1, L2, L3 might be needed in cases where the currents to be transferred through the slip ring arrangement 100 are very high. Two parallel slip rings 101, 102, 103 might also be needed in a case where the stator of the electric motor has two separate three phase windings. The slip rings 101, 102, 103 are grouped in three packages so that each package comprises two slip rings 101, 102; 102, 103; 103, 101 separated and supported by a third isolator means 161, 162, 163 situated between the two slip rings 101, 102; 102, 103; 103, 101. The third isolator means 161, 162, 163 situated between the two slip rings 101, 102; 102, 103; 103, 101 in each package does not have to extend along the whole circumference of the slip rings 101, 102; 102, 103; 103, 101. The third isolator means 161, 162, 163 could be situated only at the points where the first power supply conductors 111, 112, 113 are connected to the slip rings 101, 102; 102, 103; 103, 101. The rest of the space between the circumferences of two pairs of slip rings 101, 102; 102, 103; 103, 101 could comprise air. The surfaces of the slip rings 101, 102; 102, 103; 103, 101 which are opposite to the third isolator means 161, 162, 163 in each package forms the contact surfaces S1, S2 of said slip rings 101, 102, 103. The first slip ring 101 in the first package and the second slip ring 101 in the third package are connected to the first phase L1. The second slip ring 102 in the first package and the first slip ring 102 in the second package are connected to the second phase L2. The second slip ring 103 in the second package and the first slip ring 103 in the third package are connected to the third phase L3.

A first lower end 111A, 112A, 113A of the first power supply conductors 111, 112, 113 is fixedly attached to an upper portion of the contact surfaces S1, S2 of the respective slip rings 101, 102, 103. Second upper ends 111B, 112B, 113B of the first power supply conductors 111, 112, 113 are attached and supported at each other with first isolator means 141, 142, 143 extending horizontally in a radial direction between the first power supply conductors 111, 112, 113. The whole package comprising the slip rings 101, 102, 103, the third isolator means 161, 162, 163, the first power supply conductors 111, 112, 113 and the first isolator means 141, 142, 143 is further supported with further first insulator means 145 on the rotatable part 20. The further first isolator means 145 extends horizontally in a radial direction between the innermost first power supply conductor 111 and the rotatable part 20. The second upper ends 111B, 112B, 113B of the first power supply conductors 111, 112, 113 are connected with first cables 181, 182, 183 to the rotating part 20 into a common connection point for each phase L1, L2, L3. The lower ends 112A, 113A of the first power supply conductors 112, 113 associated with the second phase L2 and the third phase L3 are divided into two branches attached at the respective slip rings 102, 103.

A first upper end 121A, 122A, 123A of the second power supply conductors 121, 122, 123 is attached via resilient means 170 e.g. spring means to the sliding contact means 131, 132, 133 sliding on the lower portion of the contact surfaces S1, S2 of the slip rings 101, 102, 103. The sliding contact means 131, 132, 133 have a curved contact surface S3 that is adapted to the curved contact surface S1, S2 of the slip rings 101, 102, 103. The area of the curved contact surface S3 of the sliding contact means 131, 132, 133 must be big enough to be able to transfer the electric current needed in the application. Second lower ends 121B, 122B, 123B of the second power supply conductors 121, 122, 123 are attached and supported at each other with second isolator means 151, 152, 153 extending horizontally in a radial direction between the second power supply conductors 121, 122, 123. The whole package comprising the second power supply conductors 121, 122, 123, the resilient means 170 and the sliding contact means 131, 132, 133 is supported with further second insulator means 155 on the stationary part 10. The further second isolator means 155 extends horizontally in a radial direction between the innermost second power supply conductor 121 and the stationary part 10. The sliding contact means 131, 132, 133 will thus slide on the contact surfaces of the slip rings 101, 102, 103 when the rotatable part 20 rotates in relation to the stationary part 10. The second lower ends 121B, 122B, 123B of the second power supply conductors 121, 122, 123 are connected with second cables 191, 192, 193 to the stationary part 10 into a common connection point for each phase L1, L2, L3.

The packages comprising two slip rings 101, 102; 102, 103; 103, 101 are in this embodiment in a vertical position i.e. the contact surfaces S1, S2 of the slip rings 101, 102, 103 extend in the vertical direction along the width W1 of the slip rings 101, 102, 103. The packages could naturally also be in a horizontal position i.e. the contact surfaces S1, S2 of the slip rings 101, 102, 103 could extend in the horizontal direction along the width W1 of the slip rings 101, 102, 103. The first power supply conductors 111, 112, 113 and the second power supply conductors 121, 122, 123 would have to be adapted to this.

FIGS. 3-5 are not drawn on scale. The first power supply conductors 111, 112, 113 and the second power supply conductors 121, 122, 123 extend in reality only a little bit under and respectively over the slip rings 101, 102, 103. The first cables 181, 182, 183 and the second cables 191, 192, 193 can be turned with a small radius towards the stationary part 10 and the rotatable part 20 respectively. The slip ring arrangement 100 is thus low in the direction of the vertical axis Y.

The contact surfaces of the sliding contact means 131, 132, 133 are curved when the slip rings 101, 102, 103 are in the vertical position as shown in the embodiments in FIGS. 3-5. The contact surfaces of the sliding contact means 131, 132, 133 are planar in the case when the slip rings 101, 102, 103 are in the horizontal position. The radial inner and the radial outer surface of the sliding contact means 131, 132, 133 can be curved in the case when the slip rings 101, 102, 103 are in the horizontal position. The sliding contact means 131, 132, 133 are advantageously carbon brushes.

FIG. 6 shows a vertical cross section of an arrangement for transferring liquid medium or gaseous medium between a stationary and a rotatable part. The arrangement 200 comprises a stationary part 210 and a rotatable part 220. There are annular passages 230 for each medium circuit formed as annular grooves extending into the rotatable part 220. The annular grooves 230 open against the outer surface of the stationary part 210 and are sealed against the stationary part 210. There are further first transfer pipes 211 for each medium circuit passing within the stationary part 210 to a corresponding annular passage 230. There are further second transfer pipes 221 for each medium circuit passing within the rotatable part 220 to a corresponding annular passage 230. A liquid or gaseous medium can thus be transferred from the stationary part 210 to the rotatable part 220 through the annular passage 230. The figure shows only two annular passages 230, but there can naturally be any number of annular passages 230. The figure shows only one pair of transfer pipes 211, 221 connected to one annular passage 230, but there are naturally such pairs of transfer pipes 211, 221 for each annular passage 230. This arrangement for transferring liquid medium or gaseous medium can advantageously be positioned in the middle of the slip ring arrangement according to the invention. Such an arrangement will further reduce the height of the construction.

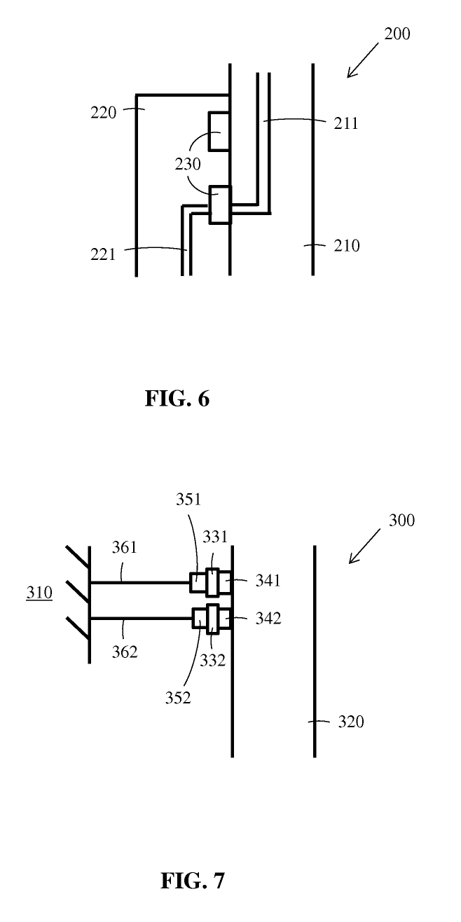

FIG. 7 shows a vertical cross section of a slip ring arrangement for transfer of electric signals between a stationary and a rotatable part. The arrangement 300 comprises a stationary part 310 and a rotatable part 320. The slip rings 331, 332 are supported through first isolator means 341, 342 at the rotatable part 320. The sliding contact means 351, 352 are supported through second isolator means 361, 362 at the stationary part 310. The figure shows only two slip rings 331, 332, but there can naturally be any number of slip rings 331, 332. The slip rings 331, 332 are used for transfer of electrical signal information between the stationary part 310 and the rotatable part 320. This means that the size of the slip rings 331, 332 is just a fraction of the size of the slip rings for transfer of electric power to the electric motor in the pod. This arrangement for transferring electric signals can advantageously be positioned in the middle of the slip ring arrangement according to the invention. Such an arrangement will further reduce the height of the construction.

The slip ring arrangements shown in FIGS. 3-4 can naturally be reversed so that the first package consisting of the first power supply conductors 111, 112, 113, the slip rings 101, 102, 103 and the first isolator means 141, 142 is attached to the stationary part 10 and the second package consisting of the second power supply conductors 121, 122, 123, the sliding contact means 131, 132, 133 and the resilient means 170 is attached to the rotatable part 20.

The slip ring arrangements shown in FIGS. 3-4 can naturally also be reversed so that the first power supply conductors 111, 112, 113 extend upwards and the second power supply conductors 121, 122, 123 extend downwards.

The second ends 111B, 112B, 113B of the first power supply conductors 111, 112, 113 are in FIGS. 3-5 supported at each other with one horizontal row of first isolator means 141, 142, 143. The second ends 121B, 122B, 123B of the second power supply conductors 121, 122, 123 are in FIGS. 3-5 supported at each other with one horizontal row of second isolator means 151, 152, 153. There could naturally be several horizontal rows of first isolator means 141, 142, 143 and several rows of second isolator means 151, 152, 153 if needed.

The support of the first power supply conductors 111, 112, 113 to either the rotatable part 20 or the stationary part 10 is in FIGS. 3-5 through a further first isolator means 145. The support of the second power supply conductors 121, 122, 123 to either the rotatable part 20 or the stationary part 10 is in FIGS. 3-5 through the further second isolator means 155. Said support to either the rotatable part 20 or the stationary part 10 can naturally be realized in any suitable way depending on the construction of the whole arrangement.

The first power supply conductors 111, 112, 113 and the second power supply conductors 121, 122, 123 extend in FIGS. 3-5 in the vertical direction. The second ends 111B, 112B, 113B of the first power supply conductors 111, 112, 113 and the second ends 121B, 122B, 123B of the second power supply conductors 121, 122, 123 could be turned 90 degrees so that they extend in the horizontal direction. The first isolator means 141, 142, 143 would then extend in the vertical direction between the second ends 111B, 112B, 113B of the first power supply conductors 111. 112. 113. The second isolator means 151, 152, 153 would then extend in the vertical direction between the second ends 121B, 122B, 123B of the second power supply conductors 121, 122, 123. The further first isolator means 145 and further second isolator means 155 would also then extend in the vertical direction. The further first isolator means 145 and the further second isolator means 155 could then be attached to a support construction extending in the horizontal direction. Such an arrangement would, however, become higher compared to the arrangement shown in FIGS. 3-5.

The slip rings 101, 102, 103 are advantageously flat busbars having a rectangular cross section. The first power supply conductors 111, 112, 113 and the second power supply conductors 121, 122, 123 are also advantageously flat busbars having a rectangular cross section.

The figures show only the slip rings 101, 1023, 103 associated with the three power phases L1, L2, L3. A slip ring for the neutral phase is naturally also needed in the arrangement. This neutral slip ring could correspond to the slip rings 101, 102, 103 for the power phases L1, L2, L3, but the cross section needed would be only half of the cross section needed for the power phases L1, L2, L3.

The first power supply conductors 111, 112, 113 extend in the embodiment shown in FIGS. 3-4 in a first direction Y1 being parallel with the centre axis Y and the second power supply conductors 121, 122, 123 extend in a second opposite direction Y2 being parallel with the centre axis Y. The first direction Y1 is downwards and the second direction Y2 is upwards in FIGS. 3-4. The situation can naturally be reversed.

The first power supply conductors 111, 112, 113 extend in the embodiment shown in FIG. 5 in the second direction Y2 being parallel to the centre axis Y and the second power supply conductors 121, 122, 123 extend in the first opposite Y1 direction being parallel with the centre axis Y. The first direction Y1 is downwards and the second direction Y2 is upwards in FIG. 5. The situation can naturally be reversed.

The dimensions T1, W1 of the slip rings 101, 102, 103 depend on the current to be transferred with the slip rings 101, 102, 103. The thickness T1 of the slip rings 101, 102, 103 could be in the range of 5 to 15 mm. advantageously 10 mm. The width W1 of the slip rings 101, 102, 103 could be in the range of 30 to 100 mm, advantageously in the range of 40 to 80 mm. The dimensions of the sliding contact means 131, 132, 133 also depend of the current to be transferred through the sliding contact means 131, 132, 133 to the slip rings 101, 102, 103. The thickness of the sliding contact means 131, 132, 133 could be in the range of 20 to 40 mm, advantageously 30 mm. The width of the sliding contact means 131, 132, 133 in the direction of the width W1 of the slip rings 101, 102, 103 could be in the range of 10 to 50 mm, advantageously in the range of 20 to 40 mm. The width of the sliding contact means 131, 132, 133 in the direction perpendicular to the width W1 of the sliding contact means 101, 102, 103 could be in the range of 10 to 70 mm, advantageously in the range of 20 to 60 mm. The sliding contact means 131, 132, 133 are dimensioned so that the current density does not exceed 2.0 A/mm² when the sliding contact means 131, 132, 133 are formed of coal brushes. The radius R3 of the innermost slip ring 103 in the arrangement could be in the range of 0.1 to 0.5 m. The radius R2 of the second slip ring 102 and the radius R1 of the first slip rings are determined by the air gap needed between the slip rings 101, 102, 103. The air gap is determined by the current and the voltage to be transferred through the slip rings arrangement. The radius R1 of the outermost slip ring 101 in the arrangement could be in the range of 0.5 to 1 m.

The slip ring arrangement according to the invention could also be used in a wind turbine for transferring power from the generator situated in a rotatable compartment i.e. a nacelle to the stationary tower.

The invention and its embodiments are not limited to the examples described above but may vary within the scope of the claims.

1. Slip ring arrangement (100) for transferring electric power between a stationary part (10) and a rotatable part (20), characterized in that the slip ring arrangement (100) comprises:
annular slip rings (101. 102, 103) being positioned coaxially around a vertical centre axis (Y) at a radial distance from each other and being made of an electrically conductive material, said slip rings (101, 102, 103) having a thickness (T1) in the horizontal direction and a width (W1) in the vertical direction and at least one contact surface (S1, S2) extending in the direction of the width (W1) of the slip ring (101, 102, 103), centre points of the width (W1) of the slip rings (101, 102, 103) being positioned in a horizontal plane (X1),
sliding contact means (131, 132, 133) arranged into sets of sliding contact means (131, 132, 133), each set of sliding contact means (131, 132, 133) comprising a sliding contact means (131, 132, 133) for each slip ring (101, 102, 103), each sliding contact means (131, 132, 133) having a contact surface (S3) being adapted to be in sliding contact with said at least one contact surface (S1, S2) of a respective slip ring (101, 102, 103), the sets of sliding contact means (131, 132, 133) being positioned at a second angular distance (α2) from each other along the circumference of the slip rings (101, 102, 103),
first power supply conductors (121, 122, 123) comprising a first end (121A, 122A, 123A) being attached to the sliding contact means (131, 132, 133) and a second opposite end (121B, 122B, 123B),
first isolator means (151, 152, 153) extending horizontally in a radial direction between the second ends (121B, 122B, 123B) of the first power supply conductors (121, 122, 123),
further first isolator means (155) supporting the package consisting of the sliding contact means (131, 132, 133), the first power supply conductors (121, 122, 123) and the first isolator means (151, 152, 153) at the stationary part (10) or the rotating part (20),
second isolator means (141, 142, 143) extending horizontally in the radial direction between the slip rings (101, 102, 103) and/or extending horizontally in the radial direction between second ends (111B, 112B, 113B) of optional second power supply conductors (111, 112, 113), an opposite first end (111A, 112A, 113A) of the optional second power supply conductors (111, 112, 113) being attached to said at least one contact surface (S1, S2) of the slip rings (101, 102, 103),
further second isolator means (145) supporting the package consisting of the slip rings (101, 102, 103), the second isolator means (141, 142, 143) and the optional second power supply conductors (111, 112, 113) at the rotating part (20) or the stationary part (10),
wherein said sliding contact means (131, 132, 133) are stationary and said slip rings (101, 102, 103) rotate with the rotating part (20) or vice a versa.

2. Slip ring arrangement according to claim 1, characterized in that the slip ring arrangement comprises second power supply conductors (111, 112, 113).

3. Slip ring arrangement according to claim 1, characterized in that the first power supply conductors (121, 122, 123) are attached via resilient means (170) to the sliding contact means (131, 132, 133).

4. Slip ring arrangement according to claim 1, characterized in that the slip rings (101, 102, 103) have been grouped in three packages so that each package comprises two slip rings (101, 102; 102, 103; 103, 101) separated by a third isolator means (161, 162, 163), the surfaces of the two slip rings (101, 102, 103) which are opposite to the third isolator means (161, 162, 163) in each package forming the contact surfaces (S1, S2) of said slip rings (101, 102, 103), said packages being positioned coaxially around the centre axis (Y) at a radial distance from each other, the optional second power supply conductors (111, 112, 113) being attached to the contact surface (S1, S2) of a respective slip ring (101, 102; 102, 103; 103, 101).

5. Slip ring arrangement according to claim 4, characterized in that each package comprises further two sliding contact means (131, 132, 133), each sliding contact means (131, 132, 133) being in sliding contact with a respective contact surface (S1, S2) of the respective slip ring (101, 102, 103), said sliding contact means (131, 132, 133) being attached via resilient means (170) to the first power supply conductors (121, 122, 123).

6. Slip ring arrangement according to claim 5, characterized in that the first slip ring (101) in the first package and the second slip ring (101) in the third package are connected into a first phase (L1), the second slip ring (102) in the first package and the first slip ring (102) in the second package are connected into a second phase (L2), the second slip ring (103) in the second package and the first slip ring (103) in the third package are connected into a third phase (L3).

7. Slip ring arrangement according to claim 1, characterized in that the optional second power supply conductors (111, 112, 113) are arranged into sets of optional second power supply conductors (111, 112, 113), each set of optional second power supply conductors (111, 112, 113) comprising an optional second power supply conductor (111, 112, 113) for each slip ring (101, 102, 103), each set of optional second power supply conductors (111, 112, 113) being positioned at a first angular distance (α1) from each other along the circumference of the slip rings (101, 102, 103), there being at least four sets of optional second power supply conductors (111, 112, 113).

8. Slip ring arrangement according to claim 1, characterized in that there are at least four sets of first power supply conductors (121, 122, 123.

9. Slip ring arrangement according to claim 1, characterized in that said slip rings (101, 102, 103) are flat busbars having a rectangular cross section.

10. Slip ring arrangement according to claim 1, characterized in that said optional second power supply conductors (111, 112, 113) and said first power supply conductors (121, 122, 123) are flat busbars having a rectangular cross section.

11. Slip ring arrangement according to claim 1, characterized in that the sliding contact means (131, 132, 133) are coal brushes.

12. Slip ring arrangement according to claim 1, characterized in that the sliding contact means (131, 132, 133) have a curved contact surface (S3) that is adapted to the curved contact surface (S1, S2) of the slip rings (101, 102, 103).

13. Slip ring arrangement according to claim 1, characterized in that the optional second power supply conductors (111, 112, 113) extend in a first vertical direction (Y1) and the first power supply conductors (121, 122, 123) extend in a second opposite vertical direction (Y2).

14. Slip ring arrangement according to claim 1, characterized in that the slip ring arrangement is used to transfer electrical power in a three phase (L1, L2, L3) electrical system with a neutral (N), the electrical power to be transferred being at least 1 MW and the current to be transferred being at least 1 kA.

15. Slip ring arrangement according to claim 1, characterized in that the slip ring arrangement comprises at least one slip ring (101, 102, 103) for each phase (L1, L2, L3) and at least one slip ring for the neutral (N) in a three phase electrical system provided with a neutral.

16. Slip ring arrangement according to claim 1, characterized in that said stationary part (10) is a hull of a vessel and said rotatable part (20) is a pod being rotatably attached to the hull of the vessel.

17. Slip ring arrangement according to claim 2, characterized in that the optional second power supply conductors (111, 112, 113) are arranged into sets of optional second power supply conductors (111, 112, 113), each set of optional second power supply conductors (111, 112, 113) comprising an optional second power supply conductor (111, 112, 113) for each slip ring (101, 102, 103), each set of optional second power supply conductors (111, 112, 113) being positioned at a first angular distance (α1) from each other along the circumference of the slip rings (101, 102, 103), there being at least four sets of optional second power supply conductors (111, 112, 113.

18. Slip ring arrangement according to claim 1, characterized in that the slip rings (101, 102, 103) have been grouped in three packages so that each package comprises two slip rings (101, 102; 102, 103; 103, 101) separated by a third isolator means (161, 162, 163), the surfaces of the two slip rings (101, 102, 103) which are opposite to the third isolator means (161, 162, 163) in each package forming the contact surfaces (S1, S2) of said slip rings (101, 102, 103), said packages being positioned coaxially around the centre axis (Y) at a radial distance from each other, the optional second power supply conductors (111, 112, 113) being attached to the contact surface (S1, S2) of a respective slip ring (101, 102; 102, 103; 103, 101).

19. Slip ring arrangement according to claim 2, characterized in that each package comprises further two sliding contact means (131, 132, 133), each sliding contact means (131, 132, 133) being in sliding contact with a respective contact surface (S1, S2) of the respective slip ring (101, 102, 103), said sliding contact means (131, 132, 133) being attached via resilient means (170) to the first power supply conductors (121, 122, 123); and wherein the slip rings (101, 102, 103) have been grouped in three packages so that each package comprises two slip rings (101, 102; 102, 103; 103, 101) separated by a third isolator means (161, 162, 163), the surfaces of the two slip rings (101, 102, 103) which are opposite to the third isolator means (161, 162, 163) in each package forming the contact surfaces (S1, S2) of said slip rings (101, 102, 103), said packages being positioned coaxially around the centre axis (Y) at a radial distance from each other, the optional second power supply conductors (111, 112, 113) being attached to the contact surface (S1, S2) of a respective slip ring (101, 102; 102, 103; 103, 101).

20. Slip ring arrangement according to claim 1, characterized in that said stationary part (10) is a hull of a vessel and said rotatable part (20) is a pod being rotatably attached to the hull of the vessel.
